(19) United States
(12) Patent Application Publication
(10) Pub. No.: US 2023/0306434 A1
(43) Pub. Date: Sep. 28, 2023

(54) SYSTEMS AND METHODS FOR REVERSING A TRANSFER OF A DIGITAL ASSET

(71) Applicant: The Toronto-Dominion Bank, Toronto (CA)

(72) Inventors: Milos DUNJIC, Oakville (CA); David Samuel TAX, Toronto (CA); Jonathan Joseph PRENDERGAST, West Chester, PA (US); Christopher Mark JONES, Villanova, PA (US); Vipul Kishore LALKA, Oakville (CA)

(73) Assignee: The Toronto-Dominion Bank, Toronto (CA)

(21) Appl. No.: 17/704,483

(22) Filed: Mar. 25, 2022

(51) Int. Cl. G06Q 20/40; G06Q 20/38

(52) U.S. Cl. CPC G06Q 20/407; G06Q 20/389

(57) ABSTRACT

Systems and methods for reversing a transfer of a digital asset are described. A method may include storing a token, the token providing for one or more transfers from a second storage location to a first storage location; receiving notification of a first transfer from the first storage location to the second storage location; detecting the first transfer from the first storage location to the second storage location; receiving a request for a reversal of the first transfer; determining an eligibility of the request for the reversal of the first transfer; and responsive to determining the eligibility of the request for the reversal of the first transfer, performing the reversal of the first transfer by executing, using the token, an offsetting transfer from the second storage location to the first storage location.

### TECHNICAL FIELD

The present application relates to digital assets and, more particularly, to reversing a transfer of a digital asset.

### BACKGROUND

A digital asset is anything that exists in a digital format and comes with the right to use. Types of digital assets include, but are not exclusive to digital paintings, photography, and electronic tickets. The ownership or origin of a digital asset may be authenticated by blockchain technology, much like a digital “signature.” As a result, although original digital assets may be copied, the value of the original digital asset does not transfer to the copy.

A digital asset may be a non-fungible token (NFT). An NFT is a digital file that has been “minted,” allowing for a secure record of ownership, and therefore the possibility of transferring that ownership. Digital assets may also include exchange mediums such as cryptocurrency and electronic representations of monetary instruments.

In some instances a sender of a digital asset may wish to, after sending the digital asset, request that the digital asset be returned. This may occur, for example, where the transfer was part of a two-way transfer in which the recipient of the digital asset was to make some transfer back to the sender but the recipient has failed to do so. Such a failure may occur for any one of a number of reasons, including, for example, due to a communication failure which may prevent the transfer back from occurring. In such situations, the sender may prefer that the transfer of the digital asset be reversed. However, in some systems, such as in some real time transfer systems in which the transfer of the digital asset is effected immediately upon request, the system may not provide for such reversals unless the recipient of the digital asset initiates a further transfer back. In some instances, such as where there is a communication failure affecting the recipient, the recipient may be unable or unwilling to initiate such a transfer.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level operation diagram of an example computing device;

FIG. 3 depicts an example simplified software organization of the example computing device of FIG. 2;

FIG. 4 is an example screen display of a client device;

FIG. 5 is a flow chart showing operations performed by a reversal system;

FIG. 6 is a flow chart showing operations performed by a reversal system;

FIG. 7 is a flow chart showing operations performed by a reversal system;

FIG. 8 is a flow chart showing operations performed by a reversal system;

FIG. 9 is an example of a first digital image;

FIG. 10 is an example screen display of a client device showing a first digital image; and

FIG. 11 is an example of a second digital image.

Like reference numerals are used in the drawings to denote like elements and features.

### DETAILED DESCRIPTION OF VARIOUS EMBODIMENTS

According to the subject-matter of the present application, there may be provided a reversal system for reversing a transfer of a digital asset, the reversal system comprising: a communications module; a processor coupled to the communications module; and a memory coupled to the processor, the memory storing processor-executable instructions which, when executed, configure the processor to store a token, the token providing for one or more transfers from a second storage location to a first storage location; receive notification of a first transfer from the first storage location to the second storage location; detect the first transfer from the first storage location to the second storage location; receive a request for a reversal of the first transfer; determine an eligibility of the request for the reversal of the first transfer; and responsive to determining the eligibility of the request for the reversal of the first transfer, perform the reversal of the first transfer by executing, using the token, an offsetting transfer from the second storage location to the first storage location.

In some implementations, the instructions, when executed, to determine the eligibility of the request for the reversal of the first transfer, further configure the processor to receive, from a first entity associated with the first storage location, a first digital image; and perform a digital image analysis of the first digital image.

In some implementations, the instructions, when executed, to determine the eligibility of the request for the reversal of the first transfer, further configure the processor to: receive, from a first entity associated with the first storage location, an indication that a good associated with the transfer has not been received; determine that an established time period has been exceeded; and determine that a proof of delivery has not been received from a second entity associated with the second storage location.

In some implementations, the instructions, when executed, to determine the eligibility of the request for the reversal of the first transfer, further configure the processor to: receive, from a first entity associated with the first storage location, a first digital image of a received good associated with the transfer; receive, from a second entity associated with the second storage location, a second digital image of a representative good associated with the transfer; perform a digital image analysis of the first digital image and the second digital image; and based on the digital image analysis of the first digital image and the second digital image, determine that the received good is defective by detecting, using a comparison engine, a type of difference between the first digital image and the second digital image.

In some implementations, the notification of the transfer from the first storage location to the second storage location includes an indication that the transfer was made over a real-time transfer rail.

In some implementations the offsetting transfer is executed using a real time transfer rail.

In some implementations, the token allows the offsetting transfer to be performed using a pre-authorized debit (PAD) procedure.

In some implementations, the instructions, when executed, further configure the processor to prior to storing the token providing for one or more transfers from the second storage location to the first storage location, register a second entity with the reversal system, the second entity being associated with the second storage location.

In some implementations, the instructions, when executed, further configure the processor to receive, from a third-party system, a request for a registration status of the second entity; and send, to the third-party system, a confirmation of the registration status of the second entity.

In some implementations, the third-party system is an institution associated with a first entity, and the first entity being associated with the first storage location. In some such implementation, the notification is received from the institution, and the notification is triggered by a determination, by the institution, that the second entity is registered with the reversal system.

According to the subject-matter of the present application, there may be provided a computer-implemented method for reversing a transfer of a digital asset. The method may comprise storing a token, the token providing for one or more transfers from a second storage location to a first storage location; receiving notification of a first transfer from the first storage location to the second storage location; detecting the first transfer from the first storage location to the second storage location; receiving a request for a reversal of the first transfer; determining an eligibility of the request for the reversal of the first transfer; and responsive to determining the eligibility of the request for the reversal of the first transfer, performing the reversal of the first transfer by executing, using the token, an offsetting transfer from the second storage location to the first storage location.

In some implementations, determining the eligibility of the request for the reversal of the first transfer comprises receiving, from a first entity associated with the first storage location, an indication that a good associated with the transfer has not been received; determining that an established time period has been exceeded; and determining that a proof of delivery has not been received from a second entity associated with the second storage location.

In some implementations, determining the eligibility of the request for the reversal of the first transfer comprises receiving, from a first entity associated with the first storage location, a first digital image of a received good associated with the transfer; receiving, from a second entity associated with the second storage location, a second digital image of a representative good associated with the transfer; performing a digital image analysis of the first digital image and the second digital image; and based on the digital image analysis of the first digital image and the second digital image, determining that the received good is defective by detecting, using a comparison engine, a type of difference between the first digital image and the second digital image.

In some implementations, the notification of the transfer from the first storage location to the second storage location includes an indication that the transfer was made over a real-time transfer rail.

In some implementations, the offsetting transfer is executed using a real time transfer rail.

In some implementations, the token allows the offsetting transfer to be performed using a pre-authorized debit (PAD) procedure.

In some implementations, prior to storing the token providing for one or more transfers from the second storage location to the first storage location, registering a second entity with a reversal system, the second entity being associated with the second storage location.

In some implementations, the method further comprises receiving, from a third-party system, a request for a registration status of the second entity; and sending, to the third-party system, a confirmation of the registration status of the second entity.

In some implementations, the third-party system is an institution associated with a first entity, and the first entity is associated with the first storage location. The notification is received from the institution, and the notification is triggered by a determination, by the institution, that the second entity is registered with the reversal system.

According to the subject-matter of the present application, there may be provided a non-transitory computer-readable storage medium comprising processor-executable instructions which, when executed, configure a processor to store a token, the token providing for one or more transfers from a second storage location to a first storage location; receive notification of a first transfer from the first storage location to the second storage location; detect the first transfer from the first storage location to the second storage location; receive a request for a reversal of the first transfer; determine an eligibility of the request for the reversal of the first transfer; and responsive to determining the eligibility of the request for the reversal of the first transfer, perform the reversal of the first transfer by executing, using the token, an offsetting transfer from the second storage location to the first storage location.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

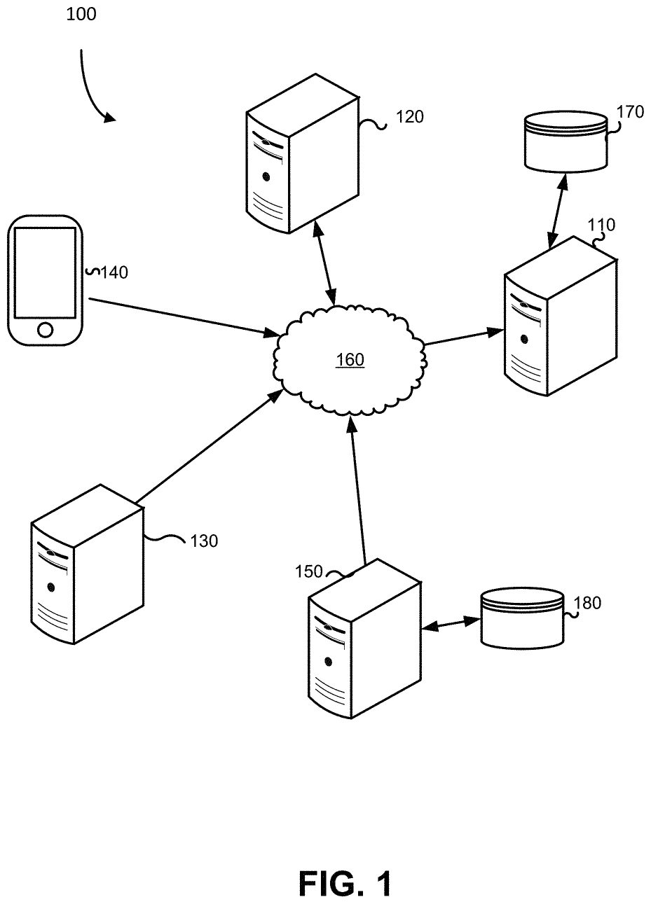

FIG. 1 is a schematic operation diagram illustrating an operating environment of an example embodiment.

As illustrated, the system 100 includes a first database management system 110, a second database management system 150, a transfer protocol server 130, a reversal system 120, and a client device 140 in communication via a network 160.

Each of the first database management system 110, the client device 140, the second database management system 150, the transfer protocol server 130, and the reversal system 120 may be in geographically disparate locations. Put differently, one or more of the first database management system 110, the client device 140, the second database management system 150, the transfer protocol server 130, and the reversal system 120 may be remote to others of the first database management system 110, the client device 140, the second database management system 150, the transfer protocol server 130, and the reversal system 120.

The first database management system 110, the client device 140, the second database management system 150, the transfer protocol server 130, and the reversal system 120 are computer systems. Computer systems may be, for example, a mainframe computer, a minicomputer, or the like. Computer systems may include one or more computing devices. For example, a computer system may include multiple computing devices such as, for example, database servers, compute servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The first database management system 110 and the second database management system 150 may each be a single server, multiple servers, a server farm, or any other such arrangement of computing devices to implement computing server-like functionality. In some embodiments, the first database management system 110 and the second database management system 150 may track, manage, and maintain owned resources belonging to respective entities. The resources may be represented in a database. For example, the first database management system 110 may be coupled to a first database 170 which may be provided in secure storage, and the second database management system 150 may be coupled to a second database 180 which may also be provided in secure storage. The secure storage(s) may be provided internally within the first and second database management systems 110, 150 or externally. The secure storage(s) may, for example, be provided remotely from the first and second database management systems 110, 150. For example, the secure storage(s) may include one or more data centers. The data centers may, for example, store data with bank-grade security.

The resources may, for example, be computing resources, such as memory or processor cycles. Additionally or alternatively, the resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economies of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

The first database 170 may include records for a plurality of accounts and at least some of the records may define a quantity of resources associated with an entity. The records may reflect a quantity of stored resources that are associated with the entity. Such resources may include owned resources. The amount of resources that are available to or associated with an entity may be reflected by a resource definition defined in an associated record. The resource definition may be or include a balance defined in an associated record; for example a bank balance. In some implementations, the resource definition may define one or more digital goods and/or digital assets that are associated with the entity.

An entity may be associated with one or more accounts storing or otherwise reflecting owned resources, i.e., an owned resource account.

In some embodiments, the first and second database management systems 110, 150 may, for example, be digital asset resource servers and the respective entities may be customers of respective institutions operating the digital asset resource servers. In some embodiments, the first and second database management systems 110, 150 may, for example, be associated financial institution servers and the respective entities may be customers of respective financial institutions operating the associated financial institution server.

The client device 140 is also a computing device. In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be associated with an entity, such as a user or client, having resources associated with the first database management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

In at least some embodiments, the transfer protocol server 130 may facilitate transfers between data records using one or more transfer protocols. A data transfer request may include a request to transfer data from a first data record to a second data record. The first data record may be a data record maintained by the second database management system 150 and the second data record may be a data record maintained by a server associated with a different system operator than the second database management system 150 (e.g., such as the first database management system 110). The transfer protocol server 130 may operate as an intermediary between the first database management system 110 and the second database management system 150. Alternatively, the first data record may be a data record maintained by the first database management system 110 and the second data record may be a data record maintained by a server associated with a different system operator than the first database management system 110 (e.g., such as the second database management system 150). The transfer protocol server 130 may operate as an intermediary between the second database management system 150 and the first database management system 110. As an example, the first data record may include a data record associated with an entity who is responsible to pay a bill and the second data record may include a data record associated with the biller, that is, the institution who issued the bill.

One or more of the transfer protocols may not require the use of a transfer protocol server. For example, one or more of the transfer protocols may operate through the exchange of messages directly between the first database management system 110 and the second database management system 150. Such messages may be exchanged through the network 160.

The reversal system 120 may initiate a transfer of data by sending a signal to the transfer protocol server 130 that includes a request to transfer data to the data record associated with the biller. In this embodiment, the transfer protocol server 130 may be configured to complete data transfers using one or more transfer protocols. In another embodiment, multiple transfer protocol servers may be used where each transfer protocol server is configured to complete data transfers using a particular transfer protocol. The transfer protocol server 130 may be associated with a third party that is different from the institution associated with the reversal system 120.

The particular transfer protocol may include a real-time transfer protocol, such as, for example, a real-time payment rail. The real-time payment rail may be hosted by a real-time payment system that includes a real-time payment server. The real-time payment server may include the transfer protocol server 130.

In at least some embodiments, the real-time payment system is associated with a third-party and is configured to receive a data transfer request. The data transfer request may include a request to transfer data from a first data record to a second data record. The first data record may include a data record associated with a sender and the second data record may include a data record associated with a receiver. The first data record may be associated with a first financial institution and the second data record may be associated with a second financial institution.

The request to transfer data may be a request to transfer resources such as for example an amount of value. The amount of value may include a quantity of currency. The sender may initiate the data transfer request using, for example, a computing device.

The data transfer request may be formatted as an ISO2022 message and may include one or more parameters. The ISO2022 format is a data-rich messaging format that provides the real-time data transfer rail with a clear and nuanced format of data. The one or more parameters may be included as metadata in the data transfer request. The one or more parameters may include resource definition data. The resource definition data defines what is requested to be transferred. By way of example, the resource definition data may define a resource that is stored in or otherwise associated with a data record associated with the sender. The resource may represent an amount of value, such as a quantity of a currency. Since the ISO2022 format is a data-rich messaging format that provides the real-time data transfer rail with a clear and nuanced format of data, the likelihood of errors and thus processing delays is minimized and as a result the real-time payment rail is able to facilitate data transfers in real-time.

Responsive to receiving the data transfer request, the real-time payment system may complete the data transfer request using the real-time payment rail. Specifically, the real-time payment server is configured to receive the data transfer request and to facilitate the data transfer from the first data record associated with the sender to the second data record associated with the receiver in real-time. In at least some embodiment, the data transfer is irrevocable, that is, the sender cannot retrieve the data transfer after it has been sent.

The real-time payment rail is able to complete data transfer requests in real-time or near real-time. In at least some embodiments, real-time is defined as being within seconds. In at least some embodiments, real-time may be limited by network traffic.

It will be appreciated that the real-time payment rail is available 24×7×365, that is, twenty-four (24) hours a day, seven (7) days a week, and three hundred and sixty-five (365) days per year.

The reversal system 120 may be a single server, multiple servers, a server farm, or any other such arrangement of computing devices to implement computing server-like functionality. Additionally or alternately, the reversal system 120 may be a component of the second database management system 150.

The reversal system 120 may provide a registration service to entities, such as seller entities. The registration service may include the maintenance of an entity's name, and other entity-identifying information, such as a merchant identifier, on a registration list.

Upon registration with the registration service, an entity may identify, to the reversal system, one or more accounts associated with the entity. The one or more accounts may have one or more records in a second storage location, such as the second database. The entity may also agree to provide, to the reversal system, notification of some or all incoming transfers to the second storage location. Each notification may include information such as the time of the transfer, the amount of the transfer, and the origin of the transfer. The origin of the transfer may be defined as a buyer account, and the buyer account may have one or more records in another storage location, such as a first storage location, such as the first database. The information may also include an identification of the transfer protocol, for example, a real-rime transfer protocol, used to complete the transfer.

The reversal system 120 may detect, through communication with the transfer protocol server 130, transfers from the first storage location to the second storage location. The reversal system 120 may communicate with the transfer protocol server 130 to determine the particular transfer protocol used to complete transfers from the first storage location to the second storage location. The particular transfer protocol may include a real-time transfer protocol, such as, for example, a real-time payment rail.

The registration service may also include the maintenance of one or more value transfer credentials associated with an entity. The credentials may include, for example, a personal account number (PAN), an expiry date and/or a verification number associated with a value transfer card.

The credential may take other forms. For example, the credential may include a token. A token may be a non-decryptable piece of data that is used to represent, by reference, value transfer data, for example, value transfer card data. Tokens may be issued by a tokenization service, which may be included in the transfer protocol server 130 or may be a separate system. The tokenization service and/or the transfer protocol server 130 stores a mapping of a token to associated information such as, for example, value transfer card data. For example, the token may be mapped to one or more of an account number such as a PAN, a date such as an expiry date, verification data such as a CCV number, and/or a token holder. The token holder may identify an entity that the token was issued to and/or is associated with. The entity may, for example, be the transfer protocol server 130. For example, the transfer protocol server 130 may permit one or more third party systems (e.g., the reversal system 120) to obtain and store a token for a particular value transfer card. The token is a representation of the value transfer card and may be stored by the reversal system 120 for future use in issuing value transfer requests. The token may be unique to the entity to which it is issued. That is, different entities that receive tokens for the same value transfer card may receive different tokens and the transfer protocol server 130 and/or the tokenization service may track which entity received which token so that an entity that issued a value transfer request that includes a token may be identified.

The entity may further provide authorization, to the reversal system, to obtain a token in association with the one or more accounts. The token may provide for one or more transfers from the second storage location to another storage location. The token may provide for an offsetting transfer, under certain conditions. In other words, the token may provide for a transfer from the second storage location to the first storage location of an amount in proportion to the amount of the incoming transfer. The token may provide for a pre-authorized debit (PAD) from the one or more accounts. The pre-authorized debit is an authorization that allows resources to be pulled from an account without requiring the associated entity to consent each time there is a transfer out of the account. In some instances, the pre-authorized debit procedure may cause the entity to be informed that a transfer is about to be processed and it may give the provide a limited time in which the entity may prevent such processing. In some embodiments, the offsetting transfer may be executed using a real-time transfer rail. The token may allow the offsetting transfer to be performed using a pre-authorized debit (PAD) procedure.

Accordingly, the reversal system 120 may use a credential associated with a value transfer card in order to initiate a transfer. In some instances, the reversal system 120 may store the credential for future use. For example, the reversal system 120 may store a representation of a value transfer card in a memory associated with the reversal system 120. The representation of the value transfer card may either be a “card on file” representation of the value transfer card or a tokenized representation of the value transfer card. In the card on file representation, the reversal system 120 stores the PAN, expiry date and, in some instances, the verification information associated with the value transfer card. In the tokenized representation, the reversal system 120 stores a token of the type referred to above.

Upon registration with the registration service, an entity may identify, to the reversal system, one or more accounts associated with the entity. The one or more accounts may have one or more records in a second storage location, such as the second database. The entity may also agree to provide, to the reversal system, notification of some or all incoming transfers to the second storage location. Each notification may include information such as the time of the transfer, the amount of the transfer, and the origin of the transfer. The origin of the transfer may be defined as a buyer account, and the buyer account may have one or more records in another storage location, such as a first storage location, such as the first database. In some embodiments, the notification may include an indication that the transfer was made over a real-time transfer rail.

The reversal system 120 may detect, through communication with the transfer protocol server 130, transfers from the first storage location to the second storage location. The reversal system 120 may communicate with the transfer protocol server 130 to determine the particular transfer protocol used to complete transfers from the first storage location to the second storage location. The particular transfer protocol may include a real-time transfer protocol, such as, for example, a real-time payment rail.

The resources may be represented in a database. May communicate with the transfer protocol server 130 in order to process a transfer of value. For example, the reversal system 120 may send to the transfer protocol server 130, a transfer request. The transfer request may specify, for example, an amount of value associated with the request. The transfer request may also include or be associated with one or more credentials associated with a value transfer card.

The reversal system 120 may include an application programming interface (API) which allows other systems, such as, for example, the first database management system 110 or a third-party system, to determine whether a particular entity is registered with the registration service. The entity may be associated with the second database management system 150, for example. A third-party system may request a registration status of an entity and may receive a confirmation of the registration status of the entity. Upon determination that an entity is registered with the registration service, the third-party system may notify the reversal system of any or all transfer from the third-party system to the entity.

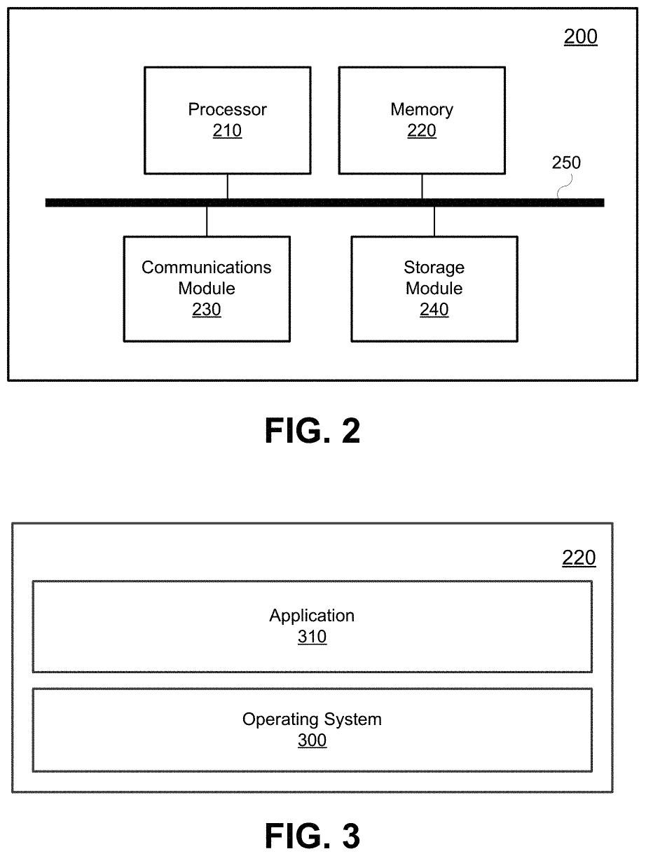

Referring now to FIG. 2, a high-level operation diagram of an example computing device 200 will now be described. The example computing device 200 may be exemplary of the first database management system 110, the client device 140, the second database management system 150, the transfer protocol server 130, and/or the reversal system 120.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The example computing device 200 will include other components apart from those illustrated in FIG. 2 and the specific component set may differ based on whether the example computing device 200 is operating as the first database management system 110, the client device 140, the second database management system 150, the transfer protocol server 130, and/or the reversal system 120. For example, the example computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the example computing device 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX™, Li™™, Mi™oft (™Windows™, Apple OSX™ or the like.

The application 310 adapts the example computing device 200, in combination with the operating system 300, to operate as a device to a particular function. For example, the application 310 may cooperate with the operating system 300 to adapt a suitable embodiment of the example computing device 200 to operate as the first database management system 110, the client device 140, the second database management system 150, the transfer protocol server 130, and the reversal system.

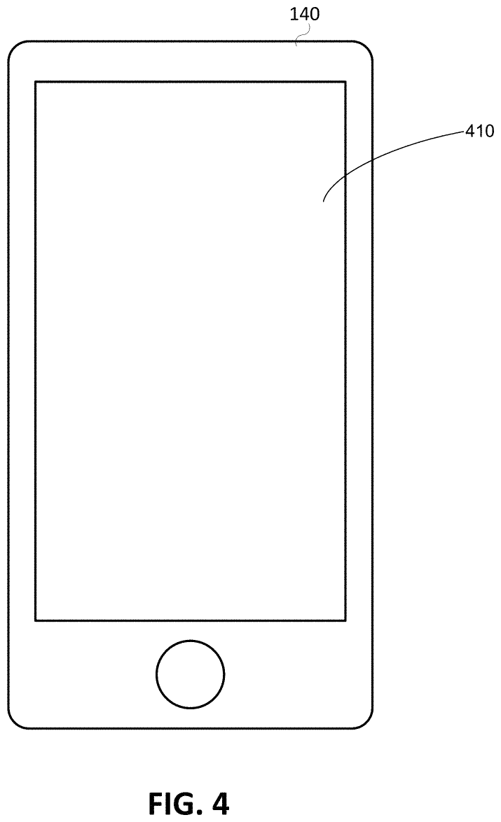

FIG. 4 shows the front of the client device 140 of FIG. 1. The client device 140 may be a personal computing device, such as a smart phone, as shown in FIG. 4. As previously described, the client device 140 may be a computing device of another type such as a laptop computer, a desktop computer, a tablet computer, a notebook computer, a hand-held computer, a personal digital assistant, a portable navigation device, a mobile phone, a wearable computing device.

As illustrated, the front of the client device 140 includes a display 410. The display 410 is a module of the smart phone embodiment of the client device 140. The display 410 is for presenting graphics. The display 410 may be, for example, a liquid crystal display (LCD). In addition to being an output device, the display 410 may also be an input device. For example, the display 410 may allow touch input to be provided to the client device 140. In other words, the display 410 may be a touch sensitive display module. In a particular example, the display 410 may be a capacitive touch screen.

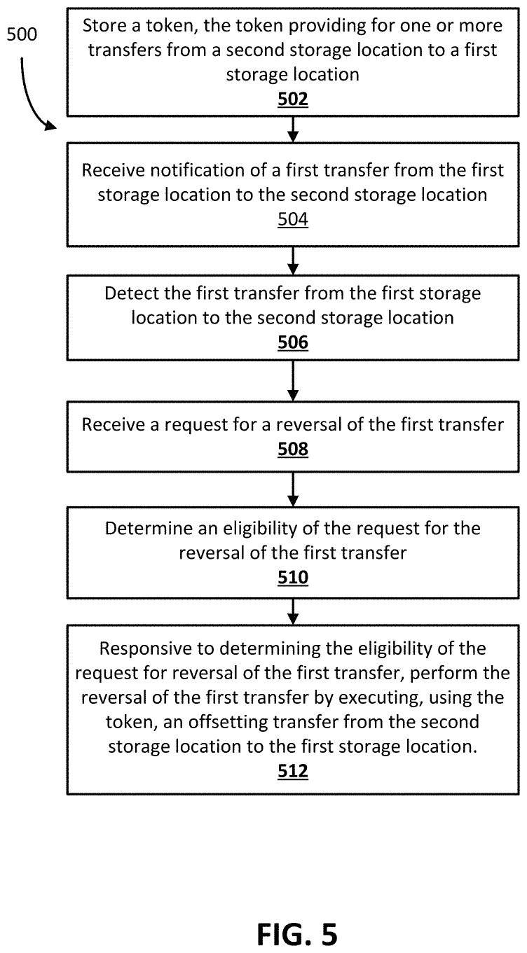

The operation of the reversal system 120 will now be described with reference to the flowchart of FIG. 5 which illustrates a method 500 for reversing a transfer of a digital asset. Operations 502 and onward are performed by one or more processors of a computing device, such as for example the processor 210 of a suitably configured instance of the example computing device 200, executing software such as, for example, a suitable instance of the application 310.

At the operation 502, the reversal system 120 stores a token. The token provides for one or more transfers from a second storage location to a first storage location. As noted, upon registration with the reversal system, an entity may provide authorization, to the reversal system, to obtain a token in association with one or more accounts associated with the entity. The token may provide for one or more transfers from the second storage location to a first storage location. The token may provide for an offsetting transfer, under certain conditions. In some embodiments, the offsetting transfer may be executed using a real-time transfer rail.

In other words, the token may provide for a transfer from the second storage location to the first storage location of an amount in proportion to the amount of the incoming transfer.

In some embodiments, the token may provide for a pre-authorized debit (PAD) from the one or more accounts. The one or more accounts may have one or more records in the second storage location, for example, the second database. The token may allow the offsetting transfer to be performed using a pre-authorized debit (PAD) procedure.

At operation 504, the reversal system receives notification of a first transfer from the first storage location to the second storage location. As noted, upon registration with the reversal system, an entity may identify, to the reversal system, one or more accounts associated with the entity. The one or more accounts may have one or more records in a second storage location, such as the second database. The entity may also agree to provide, to the reversal system, notification of some or all incoming transfers to the second storage location. Each notification may include information such as the time of the transfer, the amount of the transfer, and the origin of the transfer. The origin of the transfer may be defined as a buyer account, and the buyer account may have one or more records in another storage location, such as a first storage location, such as the first database.

As noted, the records may reflect a quantity of stored resources that are associated with the entity. Such resources may include owned resources. The amount of resources that are available to or associated with an entity may be reflected by a resource definition defined in an associated record. The resource definition may define one or more digital goods and/or digital assets and/or NFTs that are associated with the entity. In some implementations, the resource definition may be or include a balance defined in an associated record; for example a bank balance.

Additionally or alternatively, the notification may be received from an entity associated with the buyer account. In some embodiments, the notification may include an indication that the transfer was made over a real-time transfer rail.

At operation 506, the reversal system detects the first transfer from the first storage location to the second storage location. After receiving the notification of the transfer at operation 504, the reversal system confirms the transfer by detecting the first transfer from the first storage location to the second storage location. The reversal system may communicate with the transfer protocol server to confirm the transfer. The reversal system may communicate with the transfer protocol server to determine the particular transfer protocol used to complete the first transfer. The particular transfer protocol may include a real-time transfer protocol, such as, for example, a real-time payment rail. In some embodiments, detecting the first transfer from the first storage location to the second storage location involves determining that a real time transfer protocol was used to execute the first transfer. In some embodiments, the reversal system may decline to proceed with a reversal of the transfer if use of a real time payment protocol was not confirmed at the operation 506.

At operation 508, the reversal system receives a request for a reversal of the first transfer. In some embodiments, the request may be received from the first entity, and may be received from the client device. The request for a reversal of the first transfer may reference the first transfer. The request for the reversal of the first transfer may include a reason for the request.

In some embodiments, a good is associated with the first transfer. For example, the first transfer from the first storage location to the second storage location may represent one side of an exchange, such as a bilateral, reciprocal exchange between the first entity associated with the first storage location and the second entity associated with the second storage location. The other side of the exchange may include a second transfer associated with the good. The second transfer may transfer a virtual and/or a physical good from the second entity to the first entity.

In some embodiments, the reason for the request may include a failure to receive the good associated with the transfer. In some embodiments, the reason for the request may include a failure to receive the good by the first entity.

At the operation 510, the reversal system determines an eligibility of the request for the reversal of the first transfer. The determination of the eligibility of the request for the reversal of the first transfer may be automated or may be semi-automated. The determination of the eligibility of the request for the reversal of the first transfer may include one or more methods.

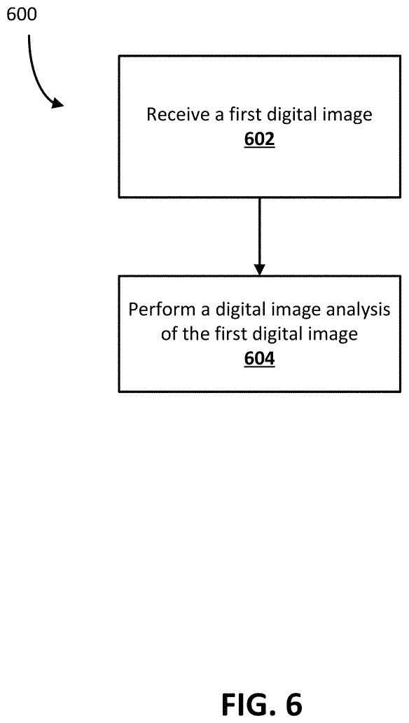

Reference is now made to FIG. 6, which illustrates a method 600 for performing a digital image analysis of a first digital image.

At operation 602, the reversal system receives, from a first entity associated with the first storage location, a first digital image.

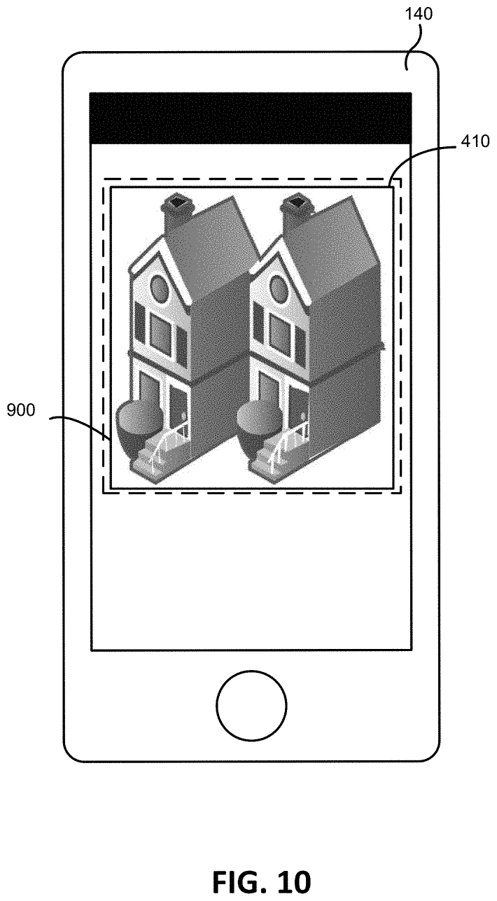

Referring now to FIG. 9, FIG. 9 illustrates an example of a first digital image 900 which may be received by the reversal system.

As noted, the first digital image 900 may be a non-fungible token (NFT). An NFT may provide a secure record of ownership, and therefore the possibility of transferring that ownership.

As further noted, a seller may place restrictions on the “return” of a purchased digital asset. After receiving a transfer of a digital asset, a buyer may wish to reverse the transfer for an acceptable reason, due to damage or to receiving the wrong item. In such cases, a timely and accurate means of reversing the transfer is desired.

Referring again to FIG. 6, at operation 604, the reversal system performs a digital image analysis of the first digital image. The digital image analysis may include identifying and verifying the NFT on a blockchain. In some embodiments, the digital image analysis may include a comparison of the first digital image to a second digital image.

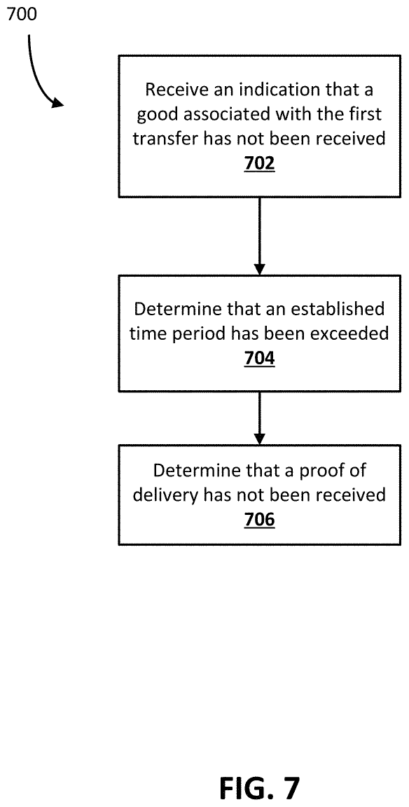

Reference is now made to FIG. 7, which is a flowchart of a first method 700 for determining the eligibility of a request for the reversal of the first transfer.

At the operation 702, the reversal system receives an indication that a good associated with the first transfer has not been received. In some embodiments, the notification may be received through an application associated with the reversal service. In some embodiments, the notification may be received via email, instant messaging (IM), telephone, an online form and/or a courier service. In some embodiments, the notification may include an indication that the transfer was made over a real-time transfer rail.

At the operation 704, the reversal system determines that an established time period has been exceeded. In some embodiments, the time period may begin at the time of the occurrence of the first transfer. In some embodiments, the time period may be a number of calendar days or a matter of business days, such as two calendar days or two business days. In some embodiments, the time period may be a number of weeks, such as one week or two weeks. In some embodiments, the time period may be a number of months.

At the operation 706, the reversal system determines that a proof of delivery has not been received. In some embodiments, the second entity may track the second transfer. As noted, the second transfer is the transfer, from the second entity to the first entity, of a good associated with the first transfer. In some embodiments, the second entity may obtain confirmation that the second transfer has been successfully completed. For example, the second entity may obtain proof of delivery of the good to the first entity. The second entity may then provide the proof of delivery to the reversal system. In some embodiments, providing such proof of delivery to the reversal system may satisfy a requirement of registration with the reversal system.

A failure to receive a proof of delivery within the time period may provide eligibility to the request for the reversal of the first transfer. Referring back to FIG. 5, at operation 512, responsive to determining the eligibility of the request for the reversal of the first transfer, the reversal system performs the reversal of the first transfer by executing, using the token, an offsetting transfer from the second storage location to the first storage location.

As noted, the reversal system may have obtained a token in association with the second entity. The token may provide for one or more transfers from the second storage location to the first storage location.

In some embodiments, the token may provide for a pre-authorized debit (PAD) from one or more accounts associated with the second entity. As noted, the pre-authorized debit is an authorization that allows resources, such as a digital asset, to be pulled from an account without requiring the account holder to consent each time there is a transfer out of the account holders account. In this way, the reversal of the first transfer may be automated.

As noted, the determination of eligibility of the request for the reversal of the first transfer, at operation 510, may include one or more methods. As further noted, the request for the reversal of the first transfer may include a reason for the request. In some embodiments, the reason for the request may include the delivery of a received good that differs from a representative good. In some instances, the difference between the received good and the representative good may represent damage to the received good.

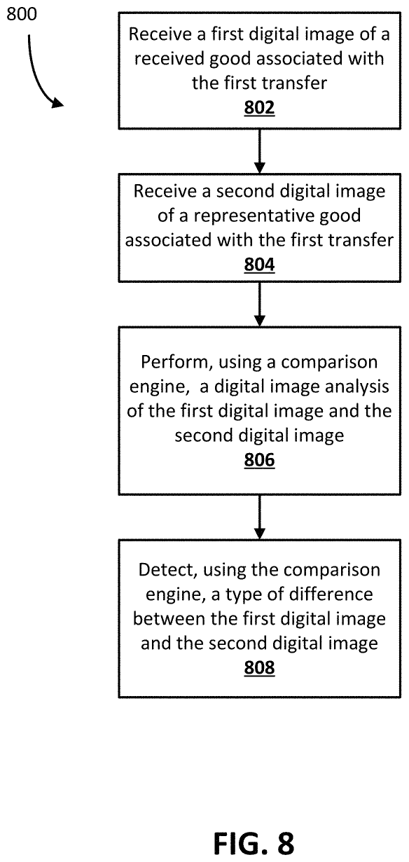

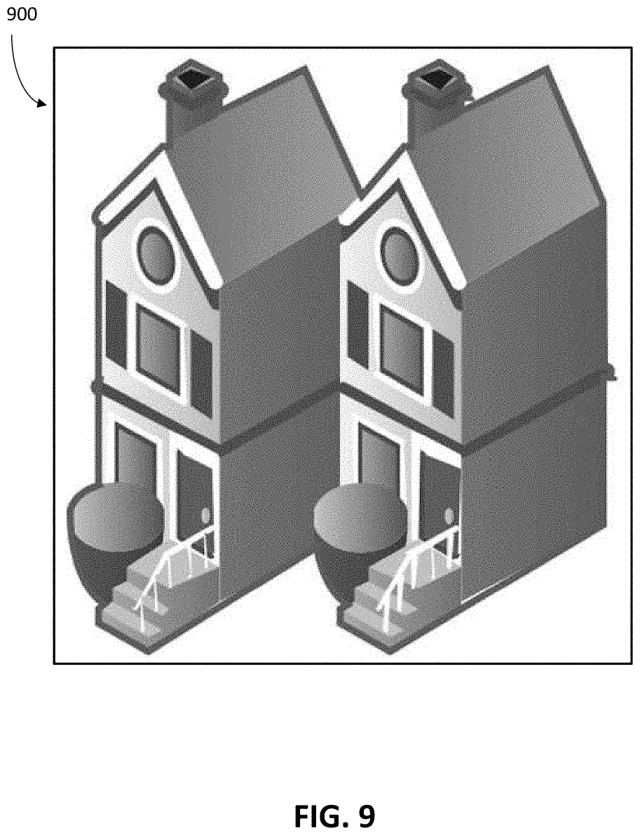

FIG. 8 illustrates a second method 800 for determining the eligibility of a request for the reversal of the first transfer.

As noted, in some embodiments, a good is associated with the first transfer. For example, the first transfer from the first storage location to the second storage location may represent one side of an exchange, such as a bilateral, reciprocal exchange between the first entity associated with the first storage location and the second entity associated with the second storage location. The other side of the exchange may include a second transfer associated with the good. The second transfer may transfer a virtual and/or a physical good from the second entity to the first entity. The good may be a digital asset.

In some embodiments, although a good may be transferred to the first entity, the good may not satisfy conditions of the exchange. For example, a received good may not resemble a representative good previously presented by the second entity in connection with the exchange. In some embodiments, the lack of resemblance between the received good and the representative good may indicate the accidental transfer of an incorrect good. In some embodiments, the lack of resemblance between the received good and the representative good may indicate damage to the received good.

At operation 802, the reversal system receives a first digital image of a received good associated with the first transfer. The digital image may be received from the first entity associated with the first storage location. The first digital image may represent the received good.

Reference is now made to FIG. 10, which illustrates a first digital image 900, a form of digital art, presented on a display 410 of a client device 140. In some embodiments, the first digital image 900 may be a received good. In some embodiments, the first digital drawing may be a first digital image representing a received good and may be received via the client device 140.

Referring again to FIG. 8, at operation 804, the reversal system receives a second digital image associated with the first transfer. The second digital image may be received from the second entity associated with the second storage location. The second digital image may represent the representative good.

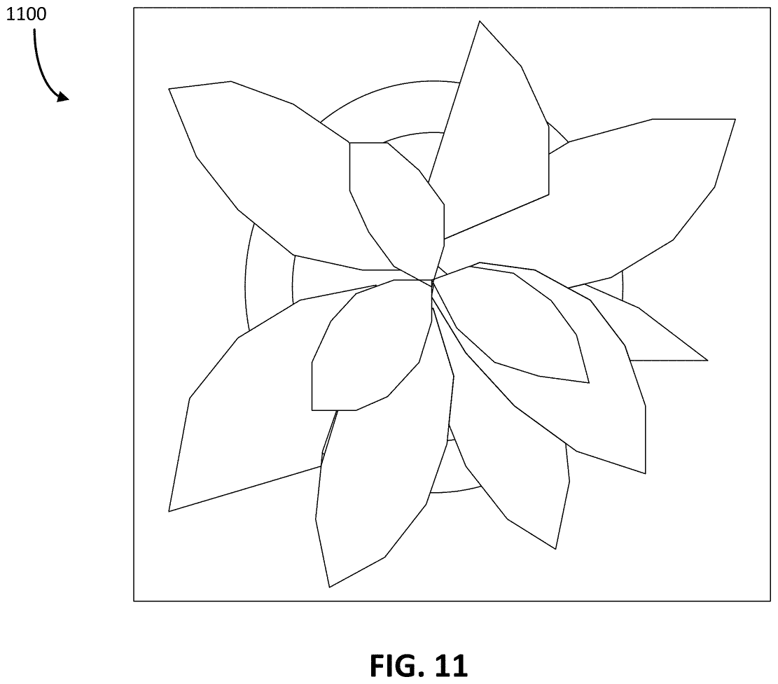

Reference is now made to FIG. 11, which illustrates a second digital image 1100, a form of digital art. In some embodiments, the second digital image 1100 may be a received good. In some embodiments, the second digital image 1100 may represent a representative good.

Referring again to FIG. 8, at operation 806, the reversal system performs, using a comparison engine, a digital image analysis of the first digital image and the second digital image. In some embodiments, the comparison engine may be a proprietary software application. In some embodiments, the comparison engine may be a third-party application operating within the reversal system, such as ACDSee™ Photo Studio, Abobe™ Lightroom and/or Bolide™ Soft Image Comparer. The third-party application may be, for example, a suitable instance of the application 310

At operation 808, the reversal system detects, using the comparison engine, a type of difference between the first digital image and the second digital image. In some embodiments, the comparison engine may determine a type of difference that indicates that the first digital image and the second digital image represent different goods. As a result, the reversal system may detect that the first digital image and the second digital image represent different goods.

In some embodiments, the comparison engine may determine a type of difference that indicates that the first digital image represents a damaged specimen of the representative good illustrated by the second digital image. As a result, the reversal system may detect that the received good represented by the first digital image is damaged.

A detection of a type of difference indicating that the first digital image and the second digital image represent different goods may provide eligibility to the request for the reversal of the first transfer. A detection of a type of difference indicating that the first digital image represents a damaged specimen of the representative good illustrated by the second digital image may also provide eligibility to the request for the reversal of the first transfer.

Referring back to FIG. 5, at operation 512, responsive to determining the eligibility of the request for the reversal of the first transfer, the reversal system performs the reversal of the first transfer by executing, using the token, an offsetting transfer from the second storage location to the first storage location.

As noted, the reversal system may have obtained a token in association with the second entity. The token may provide for one or more transfers from the second storage location to the first storage location. The offsetting transfer may be executed using a real-time transfer rail.

In some embodiments, the token may provide for a pre-authorized debit (PAD) from one or more accounts associated with the second entity. As noted, the pre-authorized debit is an authorization that allows resources, such as a digital asset, to be pulled from an account without requiring the account holder to consent each time there is a transfer out of the account holders account. In this way, the reversal of the first transfer may be automated. The token may allow the offsetting transfer to be performed using a pre-authorized debit (PAD) procedure.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A reversal system for reversing a transfer of a digital asset, the reversal system comprising:
a communications module;
a processor coupled to the communications module; and
a memory coupled to the processor, the memory storing processor-executable instructions which, when executed, configure the processor to:
store a token, the token providing for one or more transfers from a second storage location to a first storage location;
receive notification of a first transfer from the first storage location to the second storage location;
detect the first transfer from the first storage location to the second storage location;
receive a request for a reversal of the first transfer;
determine an eligibility of the request for the reversal of the first transfer; and
responsive to determining the eligibility of the request for the reversal of the first transfer, perform the reversal of the first transfer by executing, using the token, an offsetting transfer from the second storage location to the first storage location wherein the token allows the offsetting transfer to be performed using a pre-authorized debit (PAD) procedure which is an authorization that allows resources to be pulled from an account without requiring an account holder to consent each time there is a transfer out of the account.

2. The reversal system of claim 1, wherein the instructions, when executed, to determine the eligibility of the request for the reversal of the first transfer, further configure the processor to:
receive, from a first entity associated with the first storage location, a first digital image; and
perform a digital image analysis of the first digital image.

3. The reversal system of claim 1, wherein the instructions, when executed, to determine the eligibility of the request for the reversal of the first transfer, further configure the processor to:
receive, from a first entity associated with the first storage location, an indication that a good associated with the first transfer has not been received;
determine that an established time period has been exceeded; and
determine that a proof of delivery has not been received from a second entity associated with the second storage location.

4. The reversal system of claim 1, wherein the instructions, when executed, to determine the eligibility of the request for the reversal of the first transfer, further configure the processor to:
receive, from a first entity associated with the first storage location, a first digital image of a received good associated with the transfer;
receive, from a second entity associated with the second storage location, a second digital image of a representative good associated with the transfer;
perform, using a comparison engine, a digital image analysis of the first digital image and the second digital image; and
based on the digital image analysis of the first digital image and the second digital image, determine that the received good is defective by:
detecting, using the comparison engine, a type of difference between the first digital image and the second digital image.

5. The reversal system of claim 1, wherein the notification of the transfer from the first storage location to the second storage location includes an indication that the transfer was made over a real-time transfer rail.

6. The reversal system of claim 1, wherein the offsetting transfer is executed using a real time transfer rail.

7. (canceled)

8. The reversal system of claim 1, wherein the instructions, when executed,
further configure the processor to:
prior to storing the token providing for one or more transfers from the second storage location to the first storage location, register a second entity with the reversal system, the second entity being associated with the second storage location.

9. The reversal system of claim 8, wherein the instructions, when executed, further configure the processor to:
receive, from a third-party system, a request for a registration status of the second entity; and
send, to the third-party system, a confirmation of the registration status of the second entity.

10. The reversal system of claim 9,
wherein the third-party system is an institution associated with a first entity, the first entity being associated with the first storage location;
wherein the notification is received from the institution; and
wherein the notification is triggered by a determination, by the institution, that the second entity is registered with the reversal system.

11. A computer-implemented method for reversing a transfer of a digital asset, the method comprising:
storing a token, the token providing for one or more transfers from a second storage location to a first storage location;
receiving notification of a first transfer from the first storage location to the second storage location;
detecting the first transfer from the first storage location to the second storage location;
receiving a request for a reversal of the first transfer;
determining an eligibility of the request for the reversal of the first transfer; and
responsive to determining the eligibility of the request for the reversal of the first transfer, performing the reversal of the first transfer by executing, using the token, an offsetting transfer from the second storage location to the first storage location wherein the token allows the offsetting transfer to be performed using a pre-authorized debit (PAD) procedure which is an authorization that allows resources to be pulled from an account without requiring an account holder to consent each time there is a transfer out of the account.

12. The method of claim 11, wherein determining the eligibility of the request for the reversal of the first transfer comprises:
receiving, from a first entity associated with the first storage location, an indication that a good associated with the transfer has not been received;
determining that an established time period has been exceeded; and
determining that a proof of delivery has not been received from a second entity associated with the second storage location.

13. The method of claim 11, wherein determining the eligibility of the request for the reversal of the first transfer comprises:
receiving, from a first entity associated with the first storage location, a first digital image of a received good associated with the transfer;
receiving, from a second entity associated with the second storage location, a second digital image of a representative good associated with the transfer;
performing a digital image analysis of the first digital image and the second digital image; and
based on the digital image analysis of the first digital image and the second digital image, determining that the received good is defective by:
detecting, using a comparison engine, a type of difference between the first digital image and the second digital image.

14. The method of claim 11, wherein the notification of the transfer from the first storage location to the second storage location includes an indication that the transfer was made over a real-time transfer rail.

15. The method of claim 11, wherein the offsetting transfer is executed using a real time transfer rail.

16. (canceled)

17. The method of claim 11, further comprising:
prior to storing the token providing for one or more transfers from the second storage location to the first storage location, registering a second entity with a reversal system, the second entity being associated with the second storage location.

18. The method of claim 17, further comprising:
receiving, from a third-party system, a request for a registration status of the second entity; and
sending, to the third-party system, a confirmation of the registration status of the second entity.

19. The method of claim 18,
wherein the third-party system is an institution associated with a first entity, the first entity being associated with the first storage location;
wherein the notification is received from the institution; and
wherein the notification is triggered by a determination, by the institution, that the second entity is registered with the reversal system.

20. A non-transitory computer-readable storage medium comprising processor-executable instructions which, when executed, configure a processor to:
store a token, the token providing for one or more transfers from a second storage location to a first storage location;
receive notification of a first transfer from the first storage location to the second storage location;
detect the first transfer from the first storage location to the second storage location;
receive a request for a reversal of the first transfer;
determine an eligibility of the request for the reversal of the first transfer; and
responsive to determining the eligibility of the request for the reversal of the first transfer, perform the reversal of the first transfer by executing, using the token, an offsetting transfer from the second storage location to the first storage location wherein the token allows the offsetting transfer to be performed using a pre-authorized debit (PAD) procedure which is an authorization that allows resources to be pulled from an account without requiring an account holder to consent each time there is a transfer out of the account.
